(19) United States
(12) Patent Application Publication
(10) Pub. No.: US 2025/0187501 A1
(43) Pub. Date: Jun. 12, 2025

(54) VEHICLE SEAT

(71) Applicants: Hyundai Motor Company, Seoul (KR); Kia Corporation, Seoul (KR); Hyundai Transys Inc., Seosan-si (KR)

(72) Inventors: Eun Sue KIM, Hwaseong-Si (KR); Dae Hee Lee, Incheon (KR); Sang Hark Lee, Incheon (KR); Ji Yun Ha, Suwon-Si (KR); Jun Hyung Kwon, Hwaseong-Si (KR); Duk Kyu Byun, Gunpo-Si (KR); Sin Jung Kang, Hwaseong-Si (KR); Seong Bin Jung, Yongin-Si (KR)

(73) Assignees: Hyundai Motor Company, Seoul (KR); Kia Corporation, Seoul (KR); Hyundai Transys Inc., Seosan-si (KR)

(21) Appl. No.: 18/608,498

(22) Filed: Mar. 18, 2024

(30) Foreign Application Priority Data
Dec. 12, 2023 (KR) 10-2023-0179977

(51) Int. Cl. B60N 2/16; B60N 2/02; B60N 2/10

(52) U.S. Cl. CPC B60N 2/1695; B60N 2/02258; B60N 2/10

(57) ABSTRACT

A vehicle seat includes a base, a cushion frame rotatably coupled to the base, a tip-up mechanism engaged to the cushion frame and the base and configured to rotate the cushion frame with respect to the base, a cushion front frame rotatably coupled to a front portion of the cushion frame, and a tilting mechanism engaged to the cushion front frame and the cushion frame and configured to rotate a rear of the cushion front frame upward and forward with respect to the cushion frame.

### CROSS REFERENCE TO RELATED APPLICATIONS

The present application claims priority to Korean Patent Application No. 10-2023-0179977, filed Dec. 12, 2023, the entire contents of which is incorporated herein for all purposes by this reference.

### BACKGROUND OF THE PRESENT DISCLOSURE

### Field of the Present Disclosure

The present disclosure relates to a seat mounted on a vehicle.

### Description of Related Art

A vehicle seat is used in vehicles to allow occupants of a vehicle to sit comfortably while riding in the vehicle.

For normal passengers, there is no difficulty in sitting on a vehicle seat. However, for elderly passengers with weak leg muscles or passengers with lower limb disabilities, it may be difficult to handle the sudden change in posture required before and after sitting on a vehicle seat.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle seat designed to provide more human-friendly vehicle usability by assisting the elderly and disabled to sit on a seat of a vehicle as easily as possible and to stand up from the seated position.

To achieve the objective of the present disclosure, there is provided a vehicle seat including: a base, a cushion frame rotatably coupled to the base, a tip-up mechanism engaged to the cushion frame and the base and configured to rotate the cushion frame with respect to the base, a cushion front frame rotatably coupled to a front portion of the cushion frame, and a tilting mechanism engaged to the cushion front frame and the cushion frame and configured to rotate a rear of the cushion front frame upward and forward with respect to the cushion frame.

The tip-up mechanism may include: a sector gear formed integrally with an end portion of the cushion frame; and a tip-up motor fixed to the base and engaged to the sector gear to rotate the sector gear.

The tilting mechanism may include: a slider slidably mounted on the cushion frame and configured to slide straight forward and rearward with respect to the cushion frame; a tilting link pivotally connecting the slider and the cushion front frame so that a rear of the cushion front frame is rotated upward and forward with respect to the cushion frame when the slider slides rearward thereof; a tilting motor mounted on the cushion frame; and a tilting guide coupling the tilting motor and the cushion frame and configured to convert a rotational displacement of the tilting motor into a linear displacement of the tilting guide and provide the converted linear displacement to the slider.

The cushion front frame may be provided with: a tilting hinge pivotally coupling the cushion frame and the cushion front frame at a front lower side of the cushion front frame; and a rear arm, at a rear lower side of the cushion front frame, protruding toward the rear lower side to be rotatably connected to the tilting link.

A guide rail may be fixed to the cushion frame, wherein the guide rail may guide the slider so that the slider gradually moves straight upward with respect to the cushion frame when the cushion frame is in a sitting state and the slider slides rearward thereof.

The vehicle seat may further include: a joint member that connects each of the tilting link and the tilting guide to the slider, while allowing rotation of the tilting link with respect to the slider and allowing rotation of the tilting guide with respect to the slider.

The tilting motor may be provided with a rotatable drive screw, and the tilting guide may be provided with a screw nut into which the drive screw is inserted and rotated, so that a rotational displacement of the drive screw is converted to a linear displacement of the tilting guide.

The vehicle seat may further include: a controller that is operatively connected to the tip-up motor and the tilting motor and configured to control the tip-up motor and the tilting motor, wherein the controller may be configured to control the tip-up motor so that the cushion frame tips up from a sitting state to a standing state and to control the tilting motor so that the cushion front frame maintains a posture within a predetermined horizontal range.

The controller may be configured to control the tilting motor so that a front of the cushion front frame is higher than the rear of the cushion front frame within the predetermined horizontal range in the sitting state, and control the tilting motor so that the rear of the cushion front frame is higher than the front of the cushion front frame within the predetermined horizontal range in the standing state.

The predetermined horizontal range may be set as a range where an upper side of the cushion front frame forms an angle of less than 20 degrees with an imaginary horizontal plane.

To achieve the objective of the present disclosure, there is provided a vehicle seat including: a base; a cushion frame rotated with respect to the base to switch between a sitting state and a standing state; and a cushion front frame rotated with respect to the cushion frame to maintain a posture within a predetermined horizontal range while the cushion frame switches between the sitting state and the standing state.

The cushion frame may be configured to switch between the sitting state and the standing state by a sector gear provided on the cushion frame and a tip-up motor fixed to the base and engaged to the sector gear to rotate the sector gear.

The cushion front frame may be provided to be rotatable with respect to the cushion frame by a slider provided to slide straight with respect to the cushion frame and a tilting link connected to the slider.

A front lower side of the cushion front frame may be pivotally connected to the cushion frame with a tilting hinge, and a rear arm rotatably connected to the tilting link may be provided at a rear lower side of the cushion front frame.

A joint member may be provided between the slider and the tilting link to connect the tilting link to the slider to be rotatable with respect to the slider, a tilting motor may be provided in the cushion frame, and a tilting guide that converts a rotational displacement of the tilting motor into a linear displacement may be rotatably connected to the joint member.

According to an exemplary embodiment of the present disclosure, it is possible to provide more human-friendly vehicle usability by assisting the elderly and disabled to sit on a seat of a vehicle as easily as possible and to stand up from the seated position.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view showing a seat of a vehicle to which the present disclosure is applied;

FIG. 2 is a view with a cushion and a pad removed from the seat shown in FIG. 1;

FIG. 3 is a cross-sectional view taken along line III-III of FIG. 2;

FIG. 4 is a view with a seat back of FIG. 2 removed;

FIG. 5 is a view with a base of FIG. 4 removed;

FIG. 6 is a lower observation view of FIG. 5;

FIG. 7 is an exploded perspective view of FIG. 6;

FIG. 8 is a view showing the process of tilting a cushion front frame from a sitting state to a standing state according to a tilting function of a tilting mechanism; and

FIG. 9 is a view showing the process of changing from a sitting state to a standing state while a tip-up function of a tip-up mechanism and the tilting function of the tilting mechanism are performed simultaneously.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereafter, various exemplary embodiments of the present disclosure will be described in detail with reference to the accompanying drawings and the same or similar components are provided the same reference numerals regardless of the numbers of figures and are not repeatedly described.

Terms “module” and “unit” that are used for components in the following description are used only for the convenience of description without having discriminate meanings or functions.

In the following description, if it is decided that the detailed description of known technologies related to the present disclosure makes the subject matter of the exemplary embodiment described herein unclear, the detailed description is omitted. Furthermore, the accompanying drawings are provided only for easy understanding of the exemplary embodiment included in the specification, and the technical spirit included in the specification is not limited by the accompanying drawings, and all changes, equivalents, and replacements should be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

It is to be understood that when one element is referred to as being “connected to” or “coupled to” another element, it may be directly connected to or directly coupled to another element or be connected to or coupled to another element, having the other element intervening therebetween. On the other hand, it should be understood that when one element is referred to as being “directly connected to” or “directly coupled to” another element, it may be connected to or coupled to another element without the other element intervening therebetween.

Singular forms are intended to include plural forms unless the context clearly indicates otherwise.

It will be further understood that the terms “comprise” or “have” used in the present specification, specify the presence of stated features, steps, operations, components, parts, or a combination thereof, but do not preclude the presence or addition of one or more other features, numerals, steps, operations, components, parts, or a combination thereof.

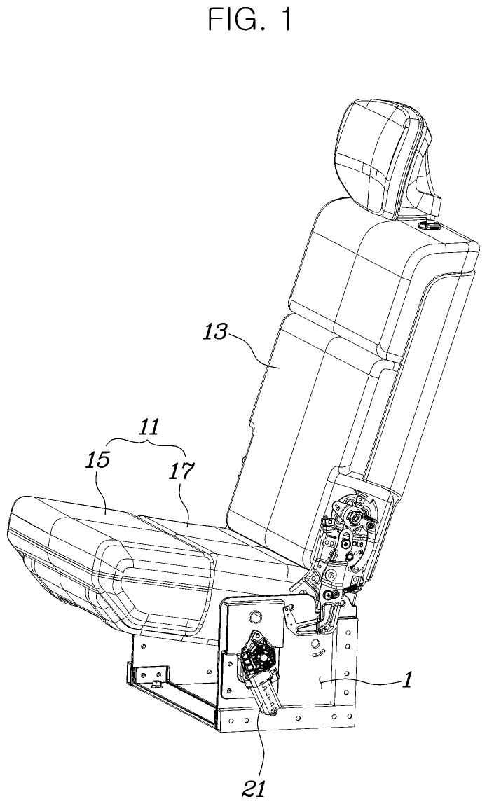

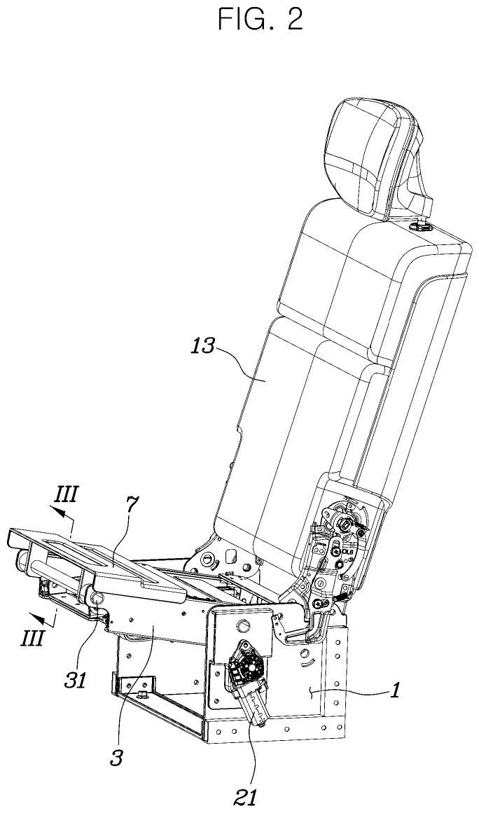

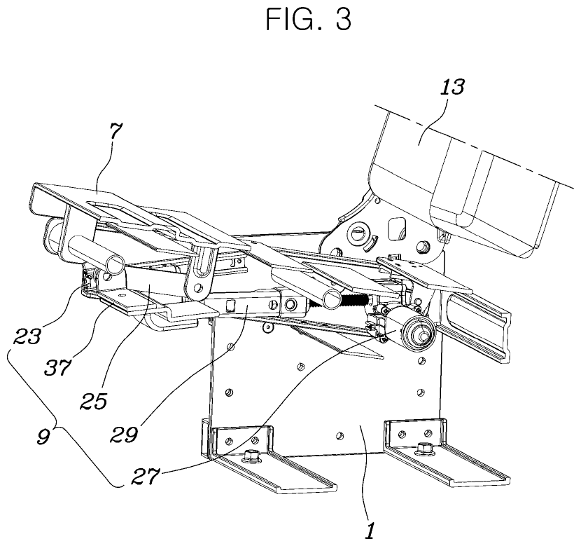

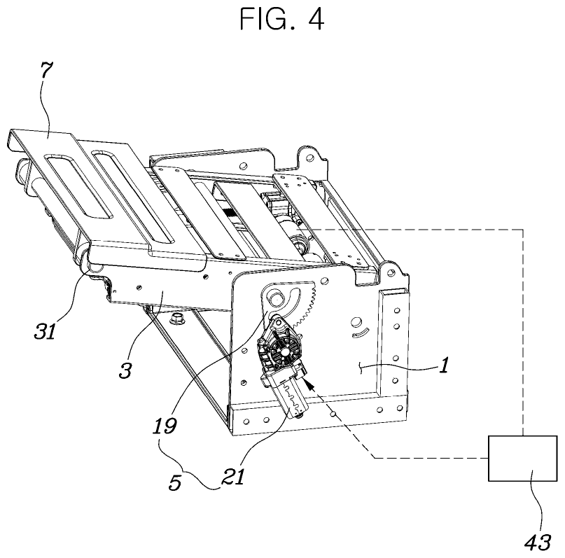

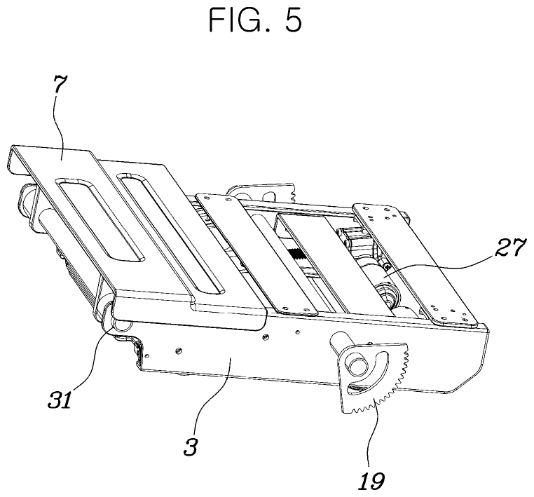

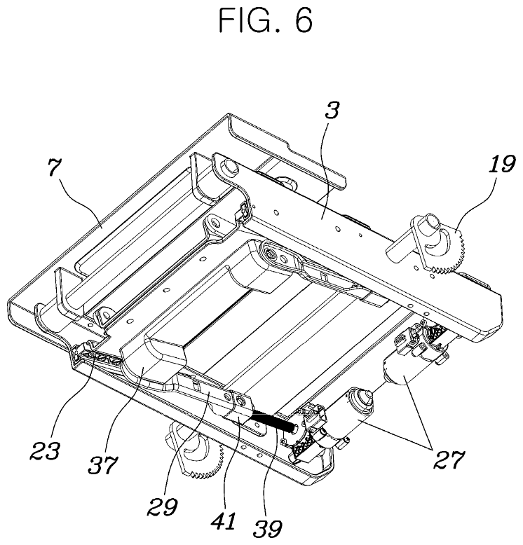

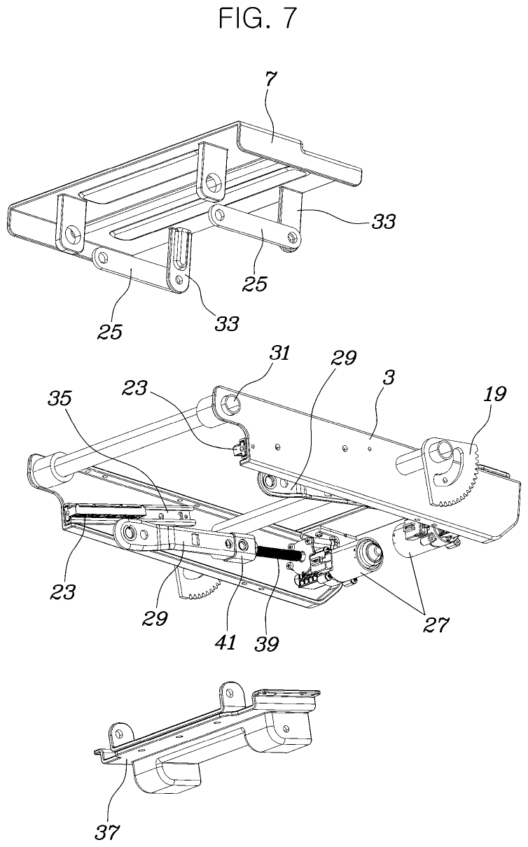

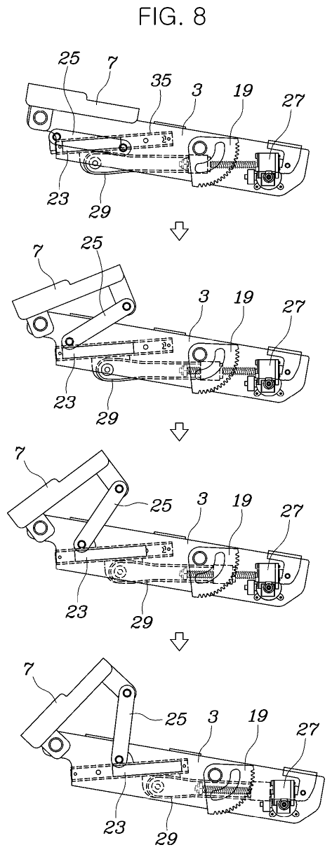

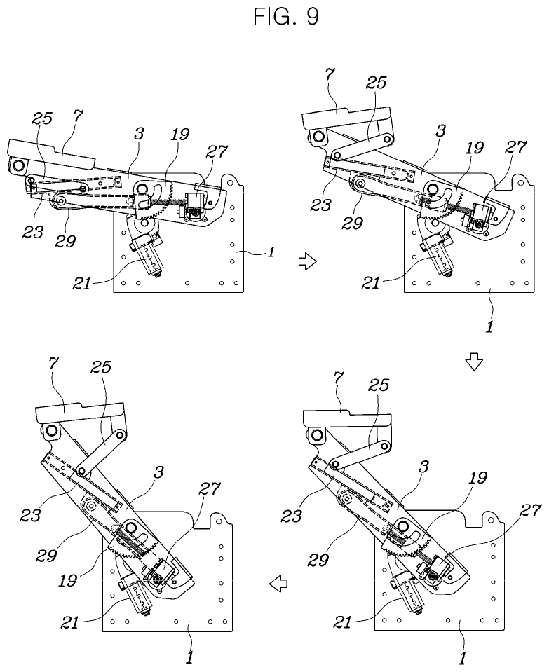

Referring to FIG. 1, FIG. 2, FIG. 3, FIG. 4, FIG. 5, FIG. 6, FIG. 7, FIG. 8 and FIG. 9, an exemplary embodiment of a vehicle seat of the present disclosure includes: a base 1; a cushion frame 3 rotatably supported on the base 1; a tip-up mechanism 5 provided to rotate the cushion frame 3 with respect to the base 1; a cushion front frame 7 rotatably supported on the front portion of the cushion frame 3; and a tilting mechanism 9 provided to rotate the rear of the cushion front frame 7 upward and forward with respect to the cushion frame 3.

That is, the vehicle seat of the present disclosure includes: the base 1 to secure the seat to a vehicle body; a seat cushion 11 provided on the base 1 and on which a passenger actually sits; and a seat back 13 that supports the rear of the seated passenger. The seat cushion 11 is divided into a front cushion 15 supported by the cushion front frame 7 and a rear cushion 17 supported by the cushion frame 3. The cushion frame 3 may be rotated so that the front side thereof moves upward while tipping up with respect to the base 1. At the instant time, the cushion front frame 7 is configured so that the rear side thereof rotates upward with respect to the cushion frame 3 and continuously supports the passenger's lower body in a posture within a predetermined horizontal range.

Accordingly, the seat of the present disclosure changes from a sitting state, which is the first state in FIG. 9, to a standing state, which is the last state, to lift the passenger's lower extremities or buttocks from the sitting state to the standing state, allowing the elderly or disabled to easily stand up from the seat. On the other hand, the seat of the present disclosure supports the lower extremities or buttocks of a passenger who wishes to sit on the seat from the standing state and gradually transitions to the sitting state, assisting the elderly or disabled to easily sit on the seat.

In the exemplary embodiment of the present disclosure, the tip-up mechanism 5 includes a sector gear 19 provided integrally with the cushion frame 3; and a tip-up motor 21 fixed to the base 1 to rotate the sector gear 19.

That is, when the tip-up motor 21 is driven, the sector gear 19 is rotated with respect to the base 1, so that the cushion frame 3 rotates with respect to the base 1, enabling a change from the sitting state to the standing state.

Meanwhile, the tilting mechanism 9 includes: a slider 23 configured to slide straight forward and rearward with respect to the cushion frame 3; a tilting link 25 connecting the slider 23 and the cushion front frame 7 so that the rear of the cushion front frame 7 may be rotated upward and forward with respect to the cushion frame 3 when the slider 23 slides rearward thereof; a tilting motor 27 provided on the cushion frame 3; and a tilting guide 29 provided to convert the rotational displacement of the tilting motor 27 into a linear displacement and provide the converted displacement to the slider 23.

That is, when the tilting motor 27 is rotated, the tilting guide 29 converts the rotational displacement of the tilting motor 27 into a linear displacement and supplies the converted displacement to the slider 23, and the slider 23 slides straight with respect to the cushion frame 3 and rotates the cushion front frame 7 with the tilting link 25.

In the exemplary embodiment of the present disclosure, the cushion front frame 7 includes a tilting hinge 31 at the front lower side thereof rotatably supported on the cushion frame 3, and a rear arm 33 at the rear lower side thereof protruding toward the rear lower side to be rotatably connected to the tilting link 25.

Furthermore, a guide rail 35 is fixed to the cushion frame 3. The guide rail 35 guides the slider 23 so that the slider 23 gradually moves straight upward with respect to the cushion frame 3 when the cushion frame 3 is in the sitting state and the slider 23 slides rearward thereof.

In the exemplary embodiment of the present disclosure, a joint member 37 is further provided. The joint member 37 connects each of the tilting link 25 and the tilting guide 29 to the slider 23, while allowing rotation of the tilting link 25 with respect to the slider 23 and allowing rotation of the tilting guide 29 with respect to the slider 23.

Meanwhile, the tilting motor 27 is provided with a rotatable drive screw 39, and the tilting guide 29 is provided with a screw nut 41 into which the drive screw 39 is inserted and rotated, so that the rotational displacement of the drive screw 39 is converted to the linear displacement of the tilting guide 29.

FIG. 8 shows only the tilting function separately when changing from the sitting state to the standing state as shown in FIG. 9. The first state is the sitting state, and the last state is the standing state.

That is, referring to FIG. 8, when the tilting motor 27 is driven in the sitting state and the tilting guide 29 is moved rearward thereof, the slider 23 moves rearward and upward on the guide rail 35 by the joint member 37, whereby the tilting link 25 pushes and rotates the rear arm 33 of the cushion front frame 7. As a result, the cushion front frame 7 is rotated counterclockwise in the drawing with respect to the cushion frame 3, transitioning to the standing state.

For reference, FIG. 9 shows that the present tilting function and the tip-up function by the sector gear 19 and the tip-up motor 21 are performed simultaneously.

That is, the present disclosure further includes a controller 43 that is configured to control the tip-up motor 21 and the tilting motor 27. The controller 43 may be configured to control the tip-up motor 21 so that the cushion frame 3 tips up from the sitting state to the standing state and to control the tilting motor 27 so that the cushion front frame 7 maintains a posture within a predetermined horizontal range.

In the instant case, the predetermined horizontal range may be set as a range where the upper side of the cushion front frame 7 forms an angle of less than 20 degrees with the horizontal plane.

That is, when the tilting function and the tip-up function are performed simultaneously according to an exemplary embodiment of the present disclosure to assist a passenger in sitting or standing, it would be desirable for the cushion front frame 7 to comfortably and stably support the passenger's lower extremities or buttocks while maintaining a generally horizontal state. Thus, the cushion front frame 7 is maintained in a generally horizontal state as shown in FIG. 9 to maintain the posture within the above predetermined horizontal range.

Furthermore, the controller 43 may be configured to control the tilting motor 27 so that the front of the cushion front frame 7 is higher than the rear of the cushion front frame 7 within the above predetermined horizontal range in the sitting state, and control the tilting motor 27 so that the rear of the cushion front frame 7 is higher than the front of the cushion front frame 7 within the above predetermined horizontal range in the standing state.

In the sitting state, if the front of the cushion front frame 7 is slightly higher than the rear, a passenger may be guided toward the seatback 13 to generate a more stable seated state, and it is possible to achieve effects such as preventing seated passengers from sliding forward on the seat when the vehicle is stopped, etc.

On the other hand, in the standing state, if the front of the cushion front frame 7 is slightly lower than the rear, when a passenger sits down, the passenger's buttocks begin to contact with the cushion front frame 7 over a relatively large area, which may further increase the sense of stability and comfort felt by the passenger.

Furthermore, when a passenger stands up from a seated state, the passenger's buttocks or lower extremities are supported over a relatively large area until just before the passenger stands up, allowing the passenger to comfortably and easily change posture from a seated state to a standing state.

Meanwhile, the present disclosure as described above may be implemented as follows.

That is, a vehicle seat of the present disclosure includes: a base 1; a cushion frame 3 rotated with respect to the base 1 to switch between sitting and standing states; and a cushion front frame 7 rotated with respect to the cushion frame 3 to maintain the posture within a predetermined horizontal range while the cushion frame 3 switches between the sitting state and the standing state.

The cushion frame 3 is configured to switch between the sitting and standing states by: a sector gear 19 provided in cushion frame 3; and tip-up motor 21 fixed to the base 1 to rotate the sector gear 19.

The cushion front frame 7 is provided to be rotatable with respect to the cushion frame 3 by: a slider 23 provided to slide linearly with respect to the cushion frame 3; and a tilting link 25 connected to the slider 23.

The front lower side of the cushion front frame 7 is rotatably provided on the cushion frame 3 with a tilting hinge 31, and a rear arm 33 rotatably connected to the tilting link 25 is provided at the rear lower side of the cushion front frame 7.

Between the slider 23 and the tilting link 25, a joint member 37 is provided to connect the tilting link 25 to the slider 23 to be rotatable with respect to the slider 23. A tilting motor 27 is provided in the cushion frame 3. A tilting guide 29 that converts the rotational displacement of the tilting motor 27 into a linear displacement is rotatably connected to the joint member 37.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle seat comprising:
a base;
a cushion frame rotatably coupled to the base;
a tip-up mechanism engaged to the cushion frame and the base and configured to rotate the cushion frame with respect to the base;
a cushion front frame rotatably coupled to a front portion of the cushion frame; and
a tilting mechanism engaged to the cushion front frame and the cushion frame and configured to rotate a rear of the cushion front frame upward and forward with respect to the cushion frame.

2. The vehicle seat of claim 1, further including:
a seat cushion mounted on the cushion frame and the cushion front frame,
wherein the seat cushion includes a front cushion coupled to the cushion front frame and a rear cushion coupled to the cushion frame.

3. The vehicle seat of claim 1, wherein the tip-up mechanism includes:
a sector gear formed integrally with an end portion of the cushion frame; and
a tip-up motor fixed to the base and engaged to the sector gear to rotate the sector gear.

4. The vehicle seat of claim 3, wherein the tilting mechanism includes:
a slider slidably mounted on the cushion frame and configured to slide straight forward and rearward with respect to the cushion frame;
a tilting link, a first end portion of which is pivotally engaged to the slider and the cushion front frame so that the rear of the cushion front frame is rotated upward and forward with respect to the cushion frame in response that the slider slides rearward thereof;
a tilting motor mounted on the cushion frame; and
a tilting guide coupling the tilting motor and the cushion frame and configured to convert a rotational displacement of the tilting motor into a linear displacement of the tilting guide and provide the converted linear displacement to the slider.

5. The vehicle seat of claim 4, wherein the cushion front frame includes:
a tilting hinge pivotally coupling the cushion frame and the cushion front frame at a front lower side of the cushion front frame; and
a rear arm, at a rear lower side of the cushion front frame, protruding toward the rear lower side and rotatably connected to a second end portion of the tilting link.

6. The vehicle seat of claim 5, further including a guide rail fixed to the cushion frame, wherein the slider is slidably engaged to the guide rail to guide the slider so that the slider moves straight upward with respect to the cushion frame in response that the cushion frame is in a sitting state and the slider slides rearward thereof.

7. The vehicle seat of claim 5, further including:
a joint member that connects each of the tilting link and the tilting guide to the slider, while allowing rotation of the tilting link with respect to the slider and allowing rotation of the tilting guide with respect to the slider.

8. The vehicle seat of claim 4, further including:
a rotatable drive screw connected to the tilting motor; and
a screw nut mounted to the tilting guide and into which the drive screw is inserted and rotated by the tilting motor, so that a rotational displacement of the drive screw is converted to the linear displacement of the tilting guide.

9. The vehicle seat of claim 4, further including:
a controller that is operatively connected to the tip-up motor and the tilting motor and configured to control the tip-up motor and the tilting motor,
wherein the controller is configured to control the tip-up motor so that the cushion frame tips up from a sitting state to a standing state and to control the tilting motor so that the cushion front frame maintains a posture within a predetermined horizontal range.

10. The vehicle seat of claim 9, wherein the controller is configured to control the tilting motor so that a front of the cushion front frame is higher than the rear of the cushion front frame within the predetermined horizontal range in the sitting state, and control the tilting motor so that the rear of the cushion front frame is higher than a front of the cushion front frame within the predetermined horizontal range in the standing state.

11. The vehicle seat of claim 9, wherein the predetermined horizontal range is set as a range where an upper side of the cushion front frame forms an angle of less than 20 degrees with an imaginary horizontal plane.

12. A vehicle seat, comprising:
a base;
a cushion frame rotated with respect to the base to switch between a sitting state and a standing state; and
a cushion front frame rotated with respect to the cushion frame to maintain a posture within a predetermined horizontal range while the cushion frame switches between the sitting state and the standing state.

13. The vehicle seat of claim 12, further including:
a seat cushion mounted on the base,
wherein the seat cushion includes a front cushion coupled to the cushion front frame and a rear cushion coupled to the cushion frame, and
wherein the cushion front frame is rotated with respect to the cushion frame to maintain the front cushion in the posture within the predetermined horizontal range while the cushion frame switches between the sitting state and the standing state.

14. The vehicle seat of claim 12, further including:
a sector gear formed on the cushion frame, and
a tip-up motor fixed to the base and engaged to the sector gear to rotate the sector gear,
wherein the cushion frame is configured to switch between the sitting state and the standing state by the sector gear and the tip-up motor.

15. The vehicle seat of claim 14, further including:
a slider slidably mounted on the cushion frame; and
a tilting link pivotally connected to the slider and the cushion front frame,
wherein the cushion front frame is rotatable with respect to the cushion frame by the slider provided to slide straight with respect to the cushion frame and the tilting link.

16. The vehicle seat of claim 15, further including:
a rear arm fixed to the cushion front frame and rotatably connected to the tilting link,
wherein a front lower side of the cushion front frame is pivotally connected to the cushion frame with a tilting hinge, and the rear arm rotatably connected to the tilting link is provided at a rear lower side of the cushion front frame.

17. The vehicle seat of claim 16, further including:
a joint member mounted between the slider and the tilting link to connect the tilting link to the slider to be rotatable with respect to the slider;
a tilting motor mounted in the cushion frame; and
a tilting guide rotatably connected to the joint member and engaged to the tilting motor to convert a rotational displacement of the tilting motor into a linear displacement of the tilting guide.

18. The vehicle seat of claim 17, further including:
a rotatable drive screw connected to the tilting motor; and
a screw nut mounted to the tilting guide and into which the drive screw is inserted and rotated by the tilting motor, so that a rotational displacement of the drive screw is converted to the linear displacement of the tilting guide.
